(19) United States
(12) Patent Application Publication
(10) Pub. No.: US 2026/0220743 A1
(43) Pub. Date: Jul. 30, 2026

(54) IMAGE PROCESSING DEVICE, IMAGE PROCESSING METHOD, AND RECORDING MEDIUM

(71) Applicant: CASIO COMPUTER CO., LTD., Tokyo (JP)

(72) Inventor: Takashi YAHATA, Tokyo (JP)

(73) Assignee: CASIO COMPUTER CO., LTD., Tokyo (JP)

(21) Appl. No.: 19/428,189

(22) Filed: Dec. 21, 2025

(30) Foreign Application Priority Data
Jan. 24, 2025 (JP) 2025-010815

(51) Int. Cl. G06T 5/40; G06T 7/00; G06T 7/90

(52) U.S. Cl. CPC G06T 5/40; G06T 7/0016; G06T 7/90; G06T 2207/10024; G06T 2207/20092; G06T 2207/30088; G06T 2207/30096

(57) ABSTRACT

An image processing device includes a memory to store a first image that is a captured image of a lesion candidate and a second image that is a captured image of the lesion candidate taken at a different time from the first image, and at least one processor to read the first image and the second image from the memory and perform correction on the first image or the second image. The at least one processor obtains a first representative luminance value in a surrounding area of the lesion candidate in the first image, obtains a second representative luminance value in a surrounding area of the lesion candidate in the second image, and corrects the luminance in the region including the lesion candidate in the second image such that the second representative luminance value in the second image after the correction equals or approaches the first representative luminance value.

### CROSS-REFERENCE TO RELATED APPLICATIONS

This application is based upon and claims the benefit of priority under 35 USC 119 of Japanese Patent Application No. 2025-010815, filed on January 24, 2025, the entire disclosure of which, including the description, claims, drawings, and abstract, is incorporated herein by reference in its entirety.

### FIELD OF THE INVENTION

The present disclosure relates to an image processing device, an image processing method, and a recording medium.

### BACKGROUND OF THE INVENTION

A technique of observing a body of a subject to diagnose the subject using a captured image of the subject is known. For example, Japanese Patent Application Publication No. 7-313469 discloses a device that evaluates skin diseases using image data.

### SUMMARY OF THE INVENTION

An image processing device according to one aspect of the present disclosure includes a memory to store a first image that is a captured image of a lesion candidate and a second image that is a captured image of the lesion candidate taken at a different time from the first image, and at least one processor to read the first image and the second image from the memory and perform correction on the first image or the second image. The at least one processor obtains, based on a histogram of luminance in a region including the lesion candidate in the first image, a first representative luminance value that is a representative value of luminance in a surrounding area of the lesion candidate in the first image, obtains, based on a histogram of luminance in a region including the lesion candidate in the second image, a second representative luminance value that is a representative value of luminance in a surrounding area of the lesion candidate in the second image, and corrects, based on the first representative luminance value and the second representative luminance value, the luminance in the region including the lesion candidate in the second image such that the second representative luminance value in the second image after the correction equals or approaches the first representative luminance value.

### BRIEF DESCRIPTION OF DRAWINGS

A more complete understanding of this application can be obtained when the following detailed description is considered in conjunction with the following drawings, in which:

FIG. 1 is a diagram illustrating an overview of an image processing system according to Embodiment 1;

FIG. 2 is a block diagram illustrating a configuration of an image processing device according to Embodiment 1;

FIG. 3A is a diagram illustrating an example of a new image according to Embodiment 1;

FIG. 3B is a diagram illustrating an example of a past image according to Embodiment 1;

FIG. 4A is a diagram illustrating an example of a target region cut out from the new image according to Embodiment 1;

FIG. 4B is a diagram illustrating an example of a target region cut out from the past image according to Embodiment 1;

FIG. 5 is a diagram illustrating an example of a luminance histogram for the target region according to Embodiment 1;

FIG. 6 is a diagram illustrating an example display of lesion candidates displayed on the image processing device according to Embodiment 1; and

FIG. 7 is a flowchart illustrating a flow of processing executed by the image processing device according to Embodiment 1.

### DETAILED DESCRIPTION OF THE INVENTION

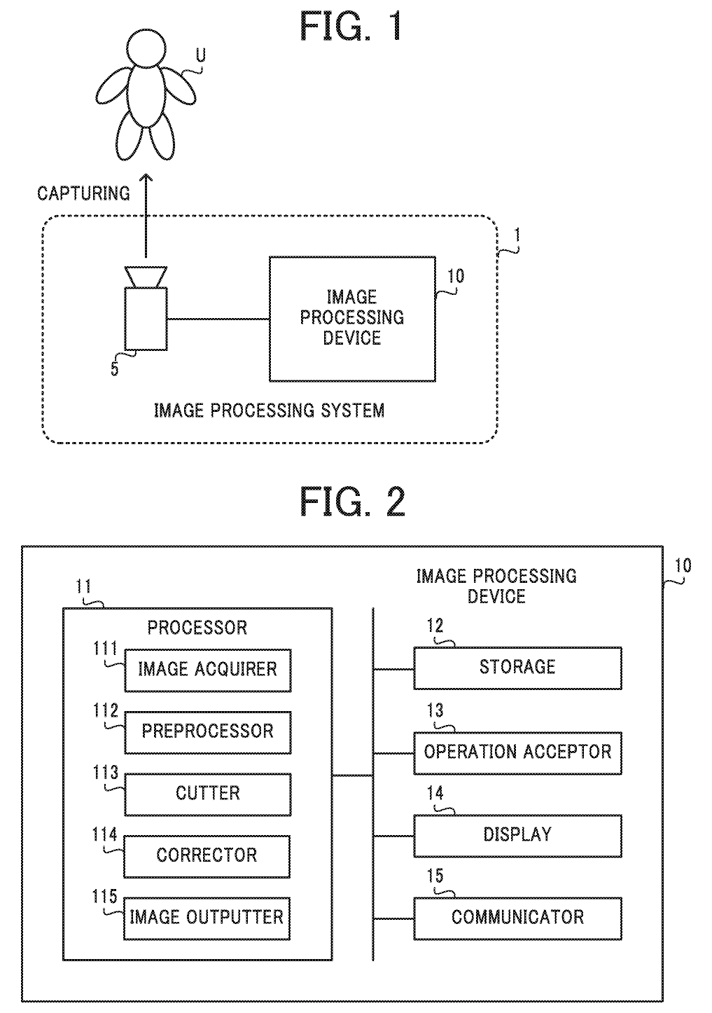

Embodiments of the present disclosure are hereinafter described with reference to the drawings. In the drawings, the same or corresponding components are denoted with the same reference signs. An image processing system 1 according to Embodiment 1 is a medical support system for diagnosing lesion candidates present in a body of a subject U based on a captured image obtained by capturing the subject U. In particular, the image processing system 1 is a system for capturing the lesion candidates in the subject U multiple times at different times and comparing and observing a plurality of images thus obtained, thereby confirming whether or not temporal changes in the lesion candidates exist. As illustrated in FIG. 1, the image processing system 1 includes an imaging device 5 and an image processing device 10.

The imaging device 5 is a device that captures an image of the subject U using light of an appropriate wavelength, such as visible light, infrared light, or ultraviolet light, to acquire the captured image acquired by capturing the subject U. The imaging device 5 includes a lens that condenses incident light, an image sensor that receives light condensed by the lens, and a readout circuit that reads out the light received by the image sensor, although illustrations thereof are omitted. The image sensor includes, for example, an imaging element such as a charged coupled device (CCD) or complementary metal oxide semiconductor (CMOS), and generates an image of the subject U. The readout circuit includes an analog/digital (A/D) converter, and converts an analog signal representing an image captured by the image sensor into digital data and outputs the digital data to the image processing device 10.

The image captured by the imaging device 5 is a medical image used for medical purposes, and is used to diagnose lesion candidates present in the body of the subject U. More specifically, the imaging device 5 captures the same subject U multiple times at different times, and acquires a plurality of captured images of the same lesion candidate present in the body of the subject U captured at different times. The captured images are used to diagnose temporal changes of the lesion candidate, in other words, to diagnose how the lesion candidate has changed with the passage of time.

The image processing device 10 is a device operated by a user, and is, for example, an information processing device such as a personal computer or a tablet terminal. Here, the user is a diagnostician who diagnoses lesion candidates, such as a doctor or other medical personnel. The image processing device 10 performs image processing on a captured image obtained by the imaging device 5 capturing lesion candidates present in the body of the subject U. As illustrated in FIG. 2, the image processing device 10 includes a processor 11, a storage 12, an operation acceptor 13, a display 14, and a communicator 15.

The processor 11 includes a central processing unit (CPU), a read only memory (ROM), and a random access memory (RAM). The CPU includes a microprocessor and the like, and is a central operation processor that executes various types of processing and operation. In the processor 11, the CPU retrieves a control program stored in the ROM and, using the RAM as a work memory, controls overall operation of the image processing device 10. Processing performed by the processor 11 may be executed by a single CPU or by a plurality of CPUs. The processor 11 may also include a processor for image processing, such as a digital signal processor (DSP) or a graphics processing unit (GPU).

The storage 12 is a non-volatile memory, such as a flash memory and a hard disk. The storage 12 stores a program and data executed by the processor 11 as well as data generated by the processor 11. The operation acceptor 13 includes an input device, such as a keyboard, a mouse, and a touch panel, and accepts operation input from a user. The display 14 includes a display device, such as a liquid crystal display and an organic electro luminescence (EL) display, and displays various types of images under the control of the processor 11. The communicator 15 includes a communication interface to communicate with a device external to the image processing device 10. For example, the communicator 15 communicates with an external device, such as the imaging device 5, in compliance with a well-known communication standard, such as a local area network (LAN) and a universal serial bus (USB).

The processor 11 functionally includes an image acquirer 111, a preprocessor 112, a cutter 113, a corrector 114, and an image outputter 115. In the processor 11, the CPU functions as the above-described functional components by retrieving programs stored in the ROM into the RAM and executing the programs to perform control. In the processor 11, a single CPU may function as each component, or a plurality of CPUs may jointly function as each component.

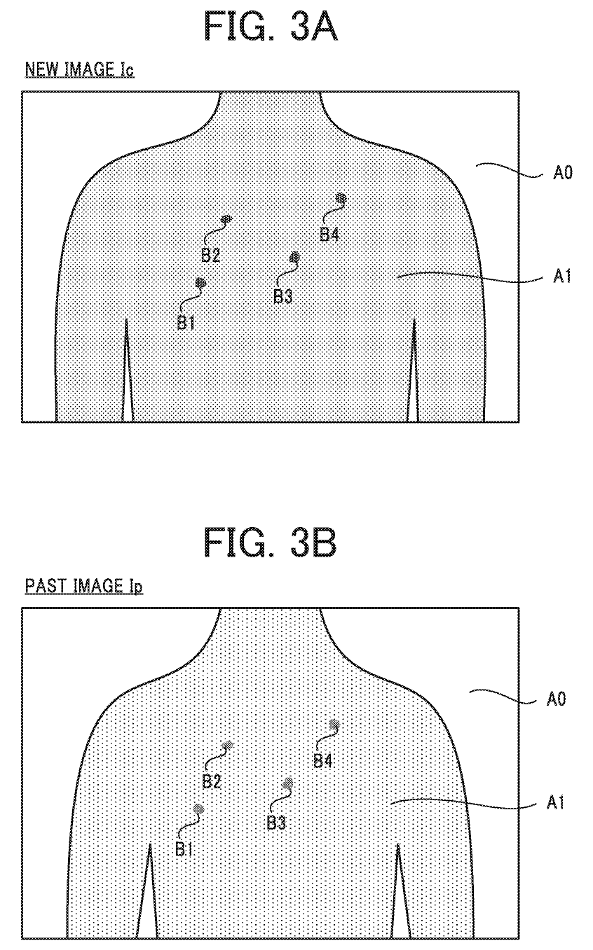

The image acquirer 111 acquires a captured image of the subject U taken by the imaging device 5. The imaging device 5 captures the subject U and thereby acquires, as captured images, for example, a new image Ic illustrated in FIG. 3A and a past image Ip illustrated in FIG. 3B. The new image Ic is a captured image of the subject U taken at a first time. In contrast, the past image Ip is a captured image of the same subject U taken at a second time earlier than the first time. Here, a time difference between the first time and the second time is an appropriate length, such as several days, weeks, months, or years, necessary to observe the temporal change of lesion candidates. Although the new image Ic and the past image Ip are images of the body of the same subject U, the different capture times result in different capture conditions, such as the posture of the subject U, the angle of view of the imaging device 5, and the brightness of the surroundings at the time of capturing.

More specifically, the new image Ic illustrated in FIG. 3A and the past image Ip illustrated in FIG. 3B are images taken from the back of the subject U, showing a wide area of the skin (surface) of the upper body of the subject U, including the neck, shoulders, and arms. In the new image Ic and the past image Ip, the region where the skin of the body of the subject U is captured is referred to as a subject region A1, and the region other than the subject region A1 is referred to as a background region A0. In the new image Ic illustrated in FIG. 3A and the past image Ip illustrated in FIG. 3B, four lesion candidates B1 to B4 are captured within the subject region A1. Here, a lesion candidate refers to a location on the body of the subject U where a pathological change may be occurring, in other words, a location where some disease may possibly arise in the body of the subject U. The possibility of a pathological change occurring means that having such a possibility is sufficient, regardless of whether the pathological change is actually occurring, or the detailed diagnosis result reveals that no pathological change is actually occurring. Hereinafter, the region in a captured image (new image Ic or past image Ip) where a lesion candidate is captured may simply be referred to as a "lesion candidate." The image acquirer 111 communicates with the imaging device 5 via the communicator 15 to acquire from the imaging device 5 the new image Ic and the past image Ip in which the lesion candidates B1 to B4 present in the body of the same subject U are captured at different times, and stores the acquired images in the storage 12.

Returning to FIG. 2, the preprocessor 112 reads from the storage 12 the new image Ic and the past image Ip stored in the storage 12 by the image acquirer 111, and executes preprocessing on the new image Ic and the past image Ip. Here, preprocessing is processing performed prior to correction processing so that the corrector 114 described later can appropriately perform the correction processing. The preprocessor 112 first identifies, from each of the new image Ic and the past image Ip, the subject region A1 in which the skin (surface) of the body of the subject U is captured. Specifically, the preprocessor 112 analyzes the pixel values of each pixel included in the new image Ic and the past image Ip, and identifies the subject region A1 from each of the new image Ic and the past image Ip based on physical features such as skin color and the shapes of body parts.

In response to identifying the subject region A1, the preprocessor 112 then detects lesion candidates from the identified subject region A1 in each of the new image Ic and the past image Ip. In other words, the preprocessor 112 detects a portion where pathological changes may be occurring in the body of the subject U from among the subject region A1 where the skin of the subject U is captured. To detect the lesion candidates, the preprocessor 112 can use a known method of image identification. In general, since the luminance of the lesion candidates is relatively low and the luminance in areas other than the lesion candidates is relatively high, the preprocessor 112 detects, as lesion candidates, areas with relatively low pixel values, i.e., relatively dark areas, compared to the surrounding area in the subject region A1. Specifically, in the example of the new image Ic illustrated in FIG. 3A and the past image Ip illustrated in FIG. 3B, the preprocessor 112 detects four lesion candidates B1 to B4 from each of the new image Ic and the past image Ip.

In response to detecting the lesion candidates B1 to B4, the preprocessor 112 performs alignment (matching) of the lesion candidates based on the positions of the lesion candidates B1 to B4 in the new image Ic and the positions of the lesion candidates B1 to B4 in the past image Ip. Specifically, even if the same part of the body of the subject U is captured, the different capture times may result in different postures of the subject U, different angles of view of the imaging device 5, and the like, at the time of capturing. Therefore, the positions of the lesion candidates B1 to B4 in the new image Ic do not exactly match the positions of the lesion candidates B1 to B4 in the past image Ip, resulting in misalignment. To correct such misalignment, the preprocessor 112 performs geometric transformation (geometric correction) on at least one of the new image Ic or the past image Ip based on the relative positional relationship between the lesion candidates B1 to B4 captured in the new image Ic and the lesion candidates B1 to B4 captured in the past image Ip.

The preprocessor 112 may use any method for aligning such lesion candidates. As an example, the preprocessor 112 can use a thinplate spline robust point matching (TPS-RPM) algorithm for non-rigid deformation. With this algorithm, the preprocessor 112 performs non-rigid deformation on at least one of the new image Ic or the past image Ip such that the same lesion candidate is in the same position in each of the new image Ic and the past image Ip. In this way, the preprocessor 112 aligns the lesion candidates B1 to B4 between the new image Ic and the past image Ip, and maps the same lesion candidates to each other.

Returning to FIG. 2, the cutter 113 cuts out the target region to be observed from the new image Ic and the past image Ip for which preprocessing has been performed by the preprocessor 112. Here, the target region is a portion of the new image Ic and the past image Ip that includes the lesion candidate that the user wants to observe in detail. Specifically, the cutter 113 displays, on the display 14, at least one of the new image Ic or the past image Ip for which preprocessing has been performed by the preprocessor 112. The user operates the operation acceptor 13 while viewing display 14 and selects, from the lesion candidates B1 to B4 captured in the new image Ic and the past image Ip, a lesion candidate that the user wants to observe in detail. Based on such operation by the user, the cutter 113 selects the lesion candidate to be observed from the lesion candidates B1 to B4. The cutter 113 then cuts out the target region, which is a region including the selected lesion candidate, from each of the new image Ic and the past image Ip.

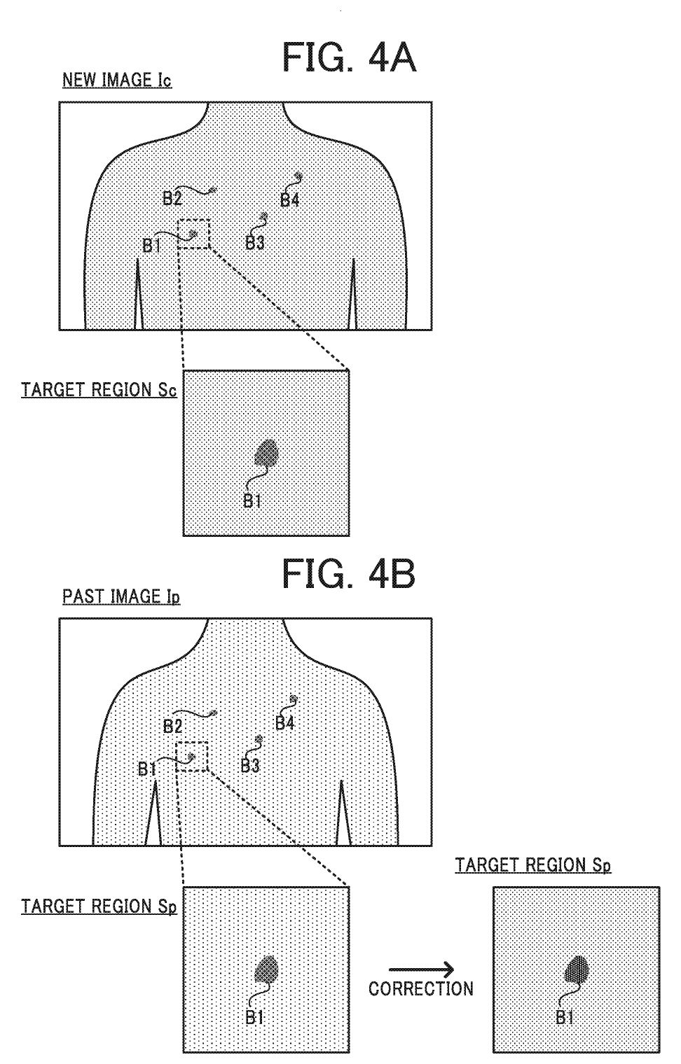

As an example, the following description uses as an example a case where the lesion candidate B1 is selected from the lesion candidates B1 to B4 by the user, but the same description can be applied to the case in which the other lesion candidates are selected. In the case where the lesion candidate B1 is selected, the cutter 113 cuts out, from the new image Ic, the target region Sc that is a region including the selected lesion candidate B1, as illustrated in FIG. 4A. Furthermore, the cutter 113 cuts out, from the past image Ip, the target region Sp that is a region including the selected lesion candidate B1, as illustrated in FIG. 4B. Here, the target regions Sc and Sp are rectangular regions that include a region of the selected lesion candidate B1 and its surrounding area. In response to the selection of the lesion candidate B1, the cutter 113 sets up a rectangular region with a size several to ten times larger than the size of the lesion candidate B1 in each of the X and Y directions based on the position of the lesion candidate B1 (e.g., the center of gravity) in each of the new image Ic and the past image Ip. The cutter 113 then cuts out the set regions as the target region Sc and Sp.

The same lesion candidates are already mapped between the new image Ic and the past image Ip by the above-described preprocessing. Therefore, even if the user selects a lesion candidate captured in one of the new image Ic and the past image Ip, the cutter 113 identifies the same lesion candidate as the selected lesion candidate from among the lesion candidates B1 to B4 captured in the other image, and cuts out the target region including the identified lesion candidate.

Returning to FIG. 2, the corrector 114 corrects the luminance in at least one of the new image Ic or the past image Ip based on the luminances in the target regions Sc and Sp cut out by the cutter 113. Specifically, by the above-described preprocessing performed by the preprocessor 112, misalignment of the lesion candidates B1 to B4 between the new image Ic and the past image Ip can be corrected, thereby correcting the differences in the posture of the subject U, the angle of view of the imaging device 5, and the like, at the time of the new image Ic and the past image Ip being captured. In contrast, since the capture times of the new image Ic and the past image Ip are different, the imaging conditions, such as the brightness of the surroundings of imaging device 5 at the time of capturing, do not exactly match, and such differences in the imaging conditions cannot be corrected. Different capture conditions hinder detailed comparative observation of the new image Ic and the past image Ip. To avoid this and facilitate comparative observation between the new image Ic and the past image Ip, the corrector 114 corrects the luminance in at least one of the new image Ic or the past image Ip. Although the corrector 114 may correct either the new image Ic or the past image Ip, the following description uses the case of correcting the past image Ip as an example. The new image Ic whose luminance is not corrected by the corrector 114 corresponds to a first image, and the past image Ip whose luminance is corrected by the corrector 114 corresponds to a second image.

To correct the luminance and chrominance in the past image Ip, the corrector 114 first converts the pixel value of each pixel in the target regions Sc and Sp cut out by the cutter 113 into luminance and chrominance components. Here, the luminance component indicates the degree of brightness in the image, and the chrominance component indicates color tone in the image. As an example, in the Lab color space (L*a*b* color space), the L component (L* component) corresponds to the luminance component, and the a component (a* component) and the b component (b* component) representing chromaticity (hue and saturation) correspond to the chrominance components. As another example, in the YUV color space, the Y component corresponds to the luminance component, and the U and V components indicating the color difference correspond to the chrominance component. The following description uses, as an example, the case of converting the pixel value of each pixel in the new image Ic and the past image Ip into the L, a, and b components in the Lab color space. However, the same description can be applied to case of using the YUV color space instead of the Lab color space.

For example, in a case where the pixel value of each pixel in the new image Ic and the past image Ip is represented by the RGB (Red, Green, Blue) color model, the corrector 114 converts the pixel value of each pixel into the L component, the a component, and the b component in accordance with a known conversion formula between the RGB color model and Lab color space. Alternatively, in a case where the pixel value of each pixel in the new image Ic and the past image Ip is represented by the CMYK (Cyan, Magenta, Yellow, Keyplate) color model, the corrector 114 converts the pixel value of each pixel into the L component, the a component, and the b component in accordance with a known conversion formula between the CMYK color model and the Lab color space. In this way, the corrector 114 converts the pixel value of each pixel in the target regions Sc and Sp into the luminance and chrominance components. In the RGB color model or the CMYK color model, the luminance and chrominance components are distributed among multiple components. Such conversion of the pixel values into the luminance and chrominance components facilitates correction of differences in brightness of the surroundings and other factors at the time of capturing.

Next, the corrector 114 obtains a representative value of the luminance in the surrounding area of the lesion candidate B1 in the new image Ic and a representative value of the luminance in the surrounding area of the lesion candidate B1 in the past image Ip. Here, the surrounding area of the lesion candidate B1 corresponds to an area other than lesion candidate B1 in the target regions Sc and Sp. The corrector 114 obtains representative values, which are representative values of the luminances of a plurality of pixels in the regions other than the lesion candidate B1, from each of the target regions Sc and Sp cut out by the cutter 113. Specifically, the corrector 114 obtains, as a representative value of the luminance in the new image Ic, an average value Yc of the luminance in the surrounding area, which is an area other than lesion candidate B1 in the target region Sc. The corrector 114 obtains, as a representative value of the luminance in the past image Ip, an average value Yp of the luminance in the surrounding area, which is an area other than the lesion candidate B1 in the target region Sp. The average value Yc is an example of a first representative luminance value, and the average value Yp is an example of a second representative luminance value.

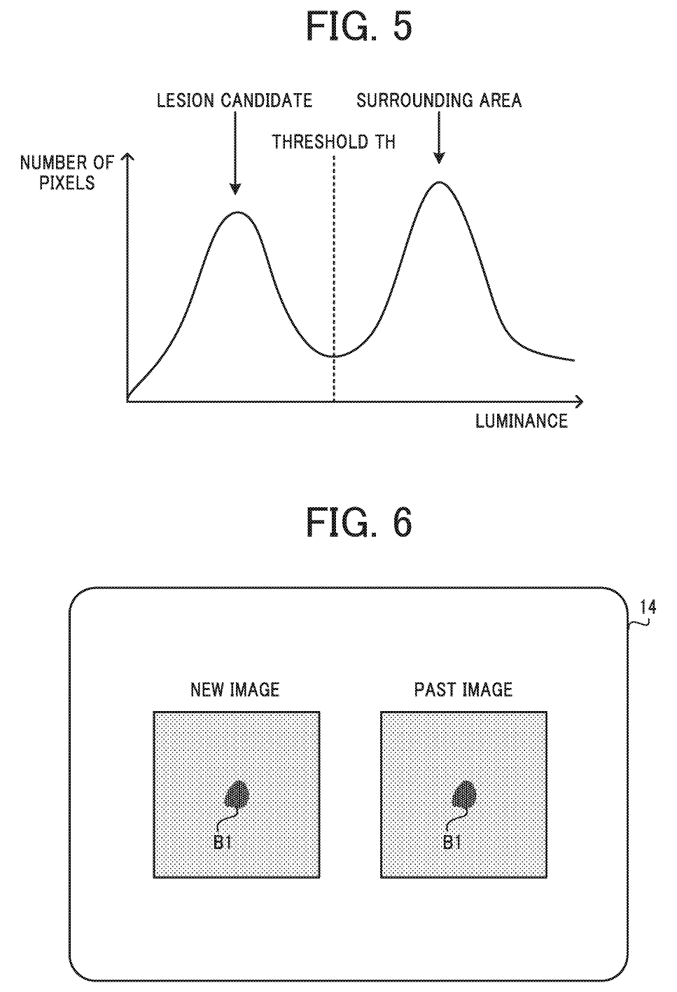

More specifically, the corrector 114 generates, for each of the target regions Sc and Sp cut out by the cutter 113, a frequency distribution, or histogram, of the luminances of the pixels included in the target region. As an example, the corrector 114 generates a luminance histogram illustrated in FIG. 5 from the luminance of each pixel included in the target region Sc. In the histogram illustrated in FIG. 5, the horizontal axis represents the luminance values and the vertical axis represents the number of pixels. In general, the histogram of luminance in the target region Sc indicates two peaks because the luminance of lesion candidates is relatively low and the luminance in the areas other than the lesion candidates is relatively high. The lower-luminance peak corresponds to the luminance at the lesion candidate B1 in the target region Sc, and the higher-luminance peak corresponds to the luminance in the surrounding area other than lesion candidate B1 in the target region Sc.

The corrector 114 sets a threshold TH based on such a luminance histogram. Then, the corrector 114 determines that the luminance below the threshold TH corresponds to the luminance in the area of the lesion candidate B1, and the luminance equal to and greater than the threshold TH corresponds to the luminance in the surrounding area of the lesion candidate B1. Here, the corrector 114 can use a known method to set the threshold TH. As an example, the corrector 114 calculates the threshold TH using Otsu's binarization technique. Specifically, in a case where the luminance of each pixel included in the target region Sc is divided into two groups by the threshold TH, the corrector 114 calculates a threshold TH that minimizes the variation of luminance within each group and maximizes the variation of luminance between the groups. The corrector 114 then sets the luminance corresponding to the valley of the two peaks as the threshold TH, as illustrated in FIG. 5, for example. In response to calculating the threshold TH in this manner, the corrector 114 calculates the average value Yc of the luminances equal to or greater than the threshold TH in the target region Sc as the representative value of the luminances in the surrounding area of the lesion candidate B1.

Furthermore, the corrector 114 performs the same processing as the target region Sc also on the target region Sp, and calculates the average value Yp. Specifically, the corrector 114 sets a threshold TH based on the histogram of luminance in the target region Sp, and calculates the average value Yp of the luminances equal to or greater than the threshold TH in the target region Sp as the representative value of the luminances in the surrounding area of the lesion candidate B1.

In response to obtaining the average values Yc and Yp, the corrector 114 sets, based on the average values Yc and Yp, a correction value for luminance in the past image Ip to be corrected. Specifically, the corrector 114 calculates a ratio p (= Yc/Yp), which is a value obtained by dividing the average value Yc obtained from the new image Ic by the average value Yp obtained from the past image Ip to be corrected, and sets the calculated ratio p as a correction value.

In response to setting the correction value is set, the corrector 114 corrects, using the set correction values, the luminance of at least a portion of the area including the lesion candidate B1 in the past image Ip to be corrected. In other words, the corrector 114 corrects differences in the capture conditions between the new image Ic and the past image Ip in order to facilitate comparative observation of the lesion candidate B1 captured in the new image Ic and the past image Ip taken at different times. Specifically, the corrector 114 multiplies the luminance of each pixel in the target region Sp cut out from the past image Ip by a ratio p (= Yc/Yp), which is the correction value. Let L denote the luminance value of a pixel in the target region Sp before correction. The corrector 114 calculates the luminance value L’ of the pixel in the target region Sp after correction as "L' = L × p." In correcting the luminance of each pixel in the target region Sp, the corrector 114 multiplies the luminance of each pixel uniformly by p by executing processing that multiplies such luminance values by the ratio p for each of the pixels in the target region Sp.

More specifically, in the examples in FIGS. 4A and 4B, the luminance in the subject region A1 is overall lower in the target region Sc than in the target region Sp. This case corresponds to the case where the surrounding environment at the time of capturing is darker in the new image Ic than in the past image Ip. In this case, the ratio p is less than 1 because the average value Yc of the luminance obtained from the new image Ic is less than the average value Yp of the luminance obtained from the past image Ip. Therefore, the corrector 114 reduces the overall luminance of each pixel in the lesion candidate B1 and its surrounding area in the target region Sp.

Specifically, the corrector 114 corrects the image of the target region Sp illustrated on the left side in the lower part FIG. 4B to the image illustrated on the right side in the lower part of FIG. 4B. As a result, the average value Yp of the luminance in the surrounding area of the lesion candidate B1 in the target region Sp after correction is equal to the average value Yc of the luminance in the surrounding area of the lesion candidate B1 in the target region Sc illustrated in FIG. 4A. In other words, the overall luminance in the target region Sp after correction is equal to the overall luminance in the target region Sc without correction of the luminance, and the difference in the capture conditions regarding luminance between the target regions Sc and Sp is corrected.

In contrast, although the illustration is omitted, in the case where the average value Yc is greater than the average value Yp, the ratio p is a value greater than 1, and thus the corrector 114 increases the overall luminance of each pixel in the lesion candidate B1 and its surrounding area in the target region Sp. Thus, the corrector 114 corrects the luminance of each pixel in the target region Sp such that the average value Yp in the target region Sp after correction equals the average value Yc in target region Sc. This corrects differences in the capture conditions regarding luminance, thus making it easier for the diagnostician to compare lesion candidates B1 captured at different times. The corrector 114 may convert the image of the target region Sp after correction of the luminance back into the format of the RGB color model or the CMYK color model, which is the format of the pixel values before conversion, as necessary.

Returning to FIG. 2, the image outputter 115 outputs the image of the lesion candidate B1 captured in the new image Ic and the image of the lesion candidate B1 captured in the past image Ip, after correction by the corrector 114. The image outputter 115 displays on the display 14 an image of the target region Sc cut out from the new image Ic and an image of the target region Sp cut out from the past image Ip and corrected for the luminance by the corrector 114, as illustrated in FIG. 6, for example. At this time, the image outputter 115 displays the two images side by side on the display screen so that the diagnostician can easily compare and observe the two images. The image outputter 115 may output these images to an external device via the communicator 15 and display the images on the display of the external device.

On such a display screen, the luminance of each pixel in the target region Sp is corrected by the corrector 114. Therefore, physicians, medical personnel, and other diagnostic personnel can compare and observe, under the equivalent capture conditions, the lesion candidates B1 captured in the new image Ic and the past image Ip taken at different capture times. This allows detailed diagnosis of temporal changes in the lesion candidate B1, leading to a high degree of accuracy.

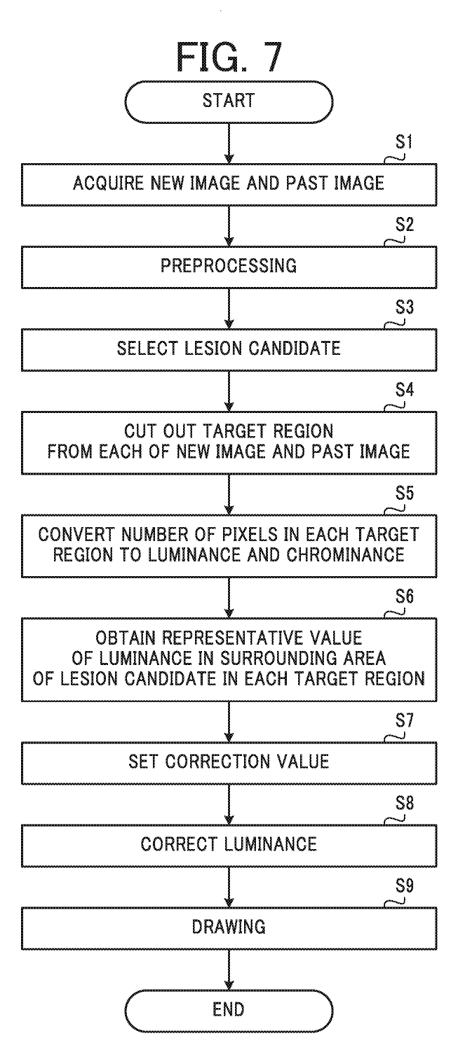

Next, a flow of processing performed by the image processing device 10 is described with reference to FIG. 7. The processing illustrated in FIG. 7 is executed at an appropriate time for the user, who is a doctor or other diagnostician, to diagnose a lesion candidate on the subject U. The processing illustrated in FIG. 7 is an example of an image processing method. First, the processor 11 functions as the image acquirer 111 to acquire the new image Ic and the past image Ip, which are captured images of the lesion candidate of subject U to be diagnosed (step S1). Specifically, the processor 11 communicates with the imaging device 5 and acquires from the imaging device 5 the new image Ic newly captured by the imaging device 5 and the past image Ip captured at a time earlier than the new image Ic, and stores the images in the storage 12. The new image Ic and the past image Ip do not necessarily have to be acquired directly from the imaging device 5. In a case where the new image Ic and the past image Ip are stored in advance on a server that is another external device, the processor 11 may acquire the new image Ic and the past image Ip from this server.

The processor 11 functions as the preprocessor 112, reads the new image Ic and the past image Ip from the storage 12, and performs preprocessing on the new image Ic and the past image Ip (step S2). Specifically, the processor 11 identifies the subject region A1 from each of the new image Ic and the past image Ip, and detects lesion candidates from the identified subject region A1. The processor 11 then aligns the lesion candidates between the new image Ic and the past image Ip.

In response to executing the preprocessing, the processor 11 selects, in accordance with a user operation, a lesion candidate to be observed from among the lesion candidates captured in each of the new image Ic and the past image Ip (step S3). Then, the processor 11 functions as the cutter 113, and cuts out the target region Sc and the target region Sp including the selected lesion candidate from the new image Ic and the past image Ip, respectively, for which preprocessing has been executed, as illustrated in FIGS. 4A and 4B, for example (step S4).

In response to cutting out the target regions Sc and Sp, the processor 11 functions as the corrector 114 until step S9 below, and converts the pixel value of each pixel in each of the target regions Sc and Sp into luminance and chrominance (step S5). Then, in each of the target regions Sc and Sp, the processor 11 obtains the representative value of luminance in the surrounding area of the lesion candidate (step S6). More specifically, the processor 11 generates a histogram of luminance as illustrated in FIG. 5 for each of the target regions Sc and Sp cut out in step S4, and sets the threshold TH based on the histogram. Then, the processor 11 obtains the average value Yc of luminance equal to or greater than the threshold TH in the target region Sc and the average value Yp of luminance equal to or greater than the threshold TH in the target region Sp as representative values of luminance.

In response to obtaining the representative value of luminance, the processor 11 sets the correction value based on the obtained representative value (step S7). Specifically, the processor 11 calculates the ratio p between the average value Yc and the average value Yp as a correction value. Then, the processor 11 corrects, using the set correction value, the luminance of the target region Sp cut out from the past image Ip to be corrected (step S8). Specifically, the processor 11 multiplies the luminance of each pixel in the target region Sp by the ratio p calculated in step S7. This corrects the overall luminance of each pixel in the target region Sp, as illustrated in the lower part of FIG. 4B, for example.

In response to correcting the luminance, the processor 11 functions as the image outputter 115, and draws, on the display screen of display 14, the image of the lesion candidate captured in the new image Ic and the image of the lesion candidate captured in the past image Ip after correction by the corrector 114 (step S9). The processor 11 displays on the display 14 the image of the target region Sc and the image of the target region Sp after correction of the luminance by the corrector 114, as illustrated in FIG. 6, for example. This allows the diagnostician to compare and observe, under the equivalent capture conditions, the lesion candidates captured in the two images taken at different times.

As described above, the image processing device 10 according to Embodiment 1 obtains the average value Yc that is a representative value of the luminance in the surrounding area of the lesion candidate in the new image Ic including the captured image of the lesion candidate, obtains the average value Yp that is a representative value of the luminance in the surrounding area of the lesion candidate in the past image Ip including the captured image of the lesion candidate taken in the earlier period than the new image Ic, and corrects, using the correction value based on the average values Yc and Yp, the luminance in the target region Sp in the past image Ip such that the average value Yp in the past image Ip after correction equals the average value Yc. Thus, the image processing device 10 according to Embodiment 1 corrects the luminance in the past image Ip such that the representative values of luminance are equal between the new image Ic and the past image Ip, thereby enabling correction of differences in the capture conditions between two images taken at different times, in other words, differences in factors other than lesion candidates. This allows the diagnostician to be less distracted by factors other than lesion candidates and to focus more readily on changes in the lesion candidates themselves. As a result, the diagnostician is better able to compare and observe the lesion candidates captured in the new image Ic and the past image Ip, and to observe temporal changes in the lesion candidates.

Next, Embodiment 2 is described. The same configuration and functions as in Embodiment 1 are omitted as appropriate. In Embodiment 1 above, the corrector 114 corrects luminance of each pixel in the target region Sp such that the average value Yp in the target region Sp after correction equals the average value Yc in the target region Sc. In contrast, in Embodiment 2, the corrector 114 corrects chrominance in the target region Sp in the same way as for luminance, instead of or in addition to the correction for luminance described in Embodiment 1. Here, the chrominance corresponds to the a and b components in the Lab color space and the U and V components in the YUV color space. The correction processing for correcting chrominance can be described in the same way by replacing "luminance" with "chrominance" in the correction processing for luminance described above.

Specifically, in Embodiment 2, the corrector 114 converts the pixel value of each pixel in the target regions Sc and Sp cut out by the cutter 113 into luminance and chrominance components. Then, the corrector 114 obtains a first representative chrominance value that is a representative value of chrominance in the surrounding area of the lesion candidate B1 in the new image Ic, and a second representative chrominance value that is a representative value of chrominance in the surrounding area of the lesion candidate B1 in the past image Ip. For this purpose, the corrector 114 generates histograms of chrominance of pixels included in the target region for each of the target regions Sc and Sp cut out by the cutter 113. The corrector 114 then sets a threshold TH based on the generated histograms of chrominance. In response to setting the threshold TH, the corrector 114 calculates, as the first representative chrominance value, the average value Yc of chrominance in the target region Sc that corresponds to the surrounding area of the lesion candidate, among the chrominances equal to or greater than the threshold TH and the chrominances less than the threshold TH in the target region Sc. Similarly, the corrector 114 calculates, as the second representative chrominance value, the average value Yp of chrominance in the target region Sp that corresponds to the surrounding area of the lesion candidate B1, among the chrominances equal to or greater than the threshold TH and the chrominances less than the threshold TH in the target region Sp.

In response to obtaining the average values Yc and Yp of chrominance, the corrector 114 sets, based on the average values Yc and Yp, the correction values of chrominance in the past image Ip to be corrected. Specifically, the corrector 114 calculates a ratio p (= Yc/Yp), which is a value obtained by dividing the average value Yc obtained from the new image Ic by the average value Yp obtained from the past image Ip to be corrected, and sets the calculated ratio p as a correction value of chrominance. In response to setting the correction value, the corrector 114 corrects, using the set correction values, the chrominance of at least a portion of the region including the lesion candidate in the past image Ip to be corrected. Specifically, the corrector 114 multiplies the chrominance of each pixel in the target region Sp cut out from the past image Ip by a ratio p (= Yc/Yp), which is the correction value. Thereby, the corrector 114 corrects the chrominance of each pixel in the target region Sp in the past image Ip such that the average value Yp in the past image Ip after the collection of the chrominance approaches the average value Yc.

The corrector 114 performs such correction processing of chrominance for each of the a component and b component corresponding to chrominance in the Lab color space. In a case where the YUV color space is used instead of the Lab color space, the corrector 114 performs such correction processing of chrominance for each of the U component and the V component in the YUV color space. Thus, in Embodiment 2, instead of or in addition to correcting the luminance of each pixel in the target region Sp, the chrominance of each pixel in the target region Sp is corrected such that the representative values of chrominance are equal between the new image Ic and the past image Ip. This allows for the correction of differences in the capture conditions relating to the chrominance between the new image Ic and the past image Ip. By correcting the differences not only in the capture conditions relating to the luminance but also in the capture conditions relating to the chrominance, the diagnostician can easily compare lesion candidates captured at different times, thus making it easier to diagnose temporal changes in the lesion candidates.

Next, Embodiment 3 is described. The same configuration and functions as in Embodiment 1 are omitted as appropriate. In Embodiments 1 and 2 above, the corrector 114 sets, as the correction value, the ratio p (= Yc/Yp), which is the value obtained by dividing the average value Yc by the average value Yp. Then, the corrector 114 corrects the luminance or the chrominance in the past image Ip by multiplying the value of the luminance or the chrominance of each pixel in the target region Sp by the ratio p. In contrast, in Embodiment 3, the corrector 114 sets, as the correction value, a difference d (= Yc − Yp), which is the value obtained by subtracting the average value Yp from the average value Yc. Then, the corrector 114 corrects the luminance or the chrominance in the past image Ip by adding the difference d to the luminance or chrominance value of each pixel in the target region Sp.

Specifically, let L denote the value of the luminance or chrominance of a pixel in the target region Sp before correction, and then the corrector 114 calculates the value L’ of the luminance or chrominance value of that pixel in the target region Sp after correction as "L' = L + d." The corrector 114 uniformly adds or subtracts an offset to or from the luminance or chrominance of each pixel by executing processing that adds the difference d to such a value of the luminance or chrominance for each of the pixels in the target region Sp.

For example, in a case where the average value Yc of the luminance or chrominance obtained from the new image Ic is smaller than the average value Yp of the luminance or chrominance obtained from the past image Ip, the difference d takes a negative value. In this case, the corrector 114 reduces the overall luminance or chrominance of each pixel in the lesion candidate B1 and its surrounding area in the target region Sp. In contrast, in a case of the average value Yc greater than the average value Yp, the difference d takes a positive value. In this case, the corrector 114 increases the overall luminance or chrominance of each pixel in the lesion candidate B1 and its surrounding area in the target region Sp.

Thus, the correction value is not limited to the use of the ratio p of the average values Yc and Yp, and using the difference d between the average values Yc and Yp, the corrector 114 can also correct the luminance or chrominance of each pixel in the target region Sp such that the average value Yp in the target region Sp after the correction equals the average value Yc. Since this allows the alignment of the capture conditions relating to the luminance or chrominance between the new image Ic and the past image Ip, the diagnostician can easily compare lesion candidates taken at different times, thus making it easier to diagnose temporal changes in the lesion candidates.

Embodiments of the present disclosure are described above, but these embodiments are merely examples and do not limit the scope of application of the present disclosure. That is, the embodiments of the present disclosure can be applied in various ways, and any embodiments are included in the scope of the present disclosure. For example, in the above embodiments, the corrector 114 obtains the average values Yc and Yp as the representative values of the luminance or chrominance in the surrounding area of the lesion candidate. However, the corrector 114 is not limited to using the average values Yc and Yp as representative values of the luminance or chrominance in the surrounding area of the lesion candidate, but may also use a mode value, a median value, etc. In the above embodiments, the corrector 114 identifies the luminance or chrominance in the surrounding area of the lesion candidate based on a histogram of the luminance or chrominance. However, the basis of the identification is not limited thereto, and the corrector 114 may, for example, identify the luminance or chrominance in the surrounding area of the lesion candidate based on the position of the lesion candidate in the image.

In the above embodiments, the corrector 114 corrects the luminance or chrominance of the target region Sp using the ratio p or the difference d of the average values Yc and Yp as the correction value such that the average value Yp, which is the representative value of the luminance or chrominance in the target region Sp after correction, equals the average value Yc, which is the representative value of the luminance or chrominance in the target region Sc. However, the way of the correction is not limited to correcting the luminance or chrominance such that the two representative values equal each other after correction, and the corrector 114 may also correct the luminance or chrominance such that the two representative values approach each other after correction. In other words, the corrector 114 may correct the luminance in the target region Sp in the past image Ip such that the second representative luminance value after correction approaches the first representative luminance value. The corrector 114 may also correct the chrominance in the target region Sp in the past image Ip such that the second representative chrominance value after correction approaches the first representative chrominance value. For example, in a case where the second representative luminance value is greater than the first representative luminance value, the corrector 114 reduces the luminance of each pixel in the target region Sp such that the second representative luminance value after correction approaches the first representative luminance value. In contrast, in a case where the second representative luminance value is less than the first representative luminance value, the corrector 114 increases the luminance of each pixel in the target region Sp such that the second representative luminance value after correction approaches the first representative luminance value. The same also applies to chrominance. Thus, the correction by the corrector 114 does not necessarily require that the two representative values after correction equal each other, as long as the difference between the two representative values after the luminance or chrominance correction becomes less than the difference before the luminance or chrominance correction. Even without the two representative values after correction being equal, the capture conditions of the two images taken at the different times can approach each other by correcting the luminance or chrominance such that the two representative values approach each other. This facilitates comparative observation of the lesion candidates captured in the two images taken at different times, making it easier to diagnose temporal changes in the lesion candidates.

In the above embodiments, the corrector 114 corrects the luminance or chrominance of the target region Sp, which is the region including the lesion candidate in the past image Ip, using the past image Ip as a correction target. However, the corrector 114 may correct the luminance or chrominance of the target region Sc, which is the region including the lesion candidate in the new image Ic, using the new image Ic as the correction target. In the case of using the new image Ic as the correction target, the new image Ic corresponds to the second image, and the past image Ip corresponds to the first image. Furthermore, the corrector 114 may correct the luminance or chrominance in both the new image Ic and the past image Ip in the case of correcting such that the representative values of the two images after correction equal or approach each other. In that case, either the new image Ic or the past image Ip can be designated as the first image or the second image.

In the above embodiments, the new image Ic and the past image Ip are captured images of the skin of the subject U, for diagnosis of the lesion candidates on the skin of the subject U. However, the new image Ic and the past image Ip may be captured images of parts other than the skin of the subject U, as long as the images are used to diagnose temporal changes in the lesion candidates. The new image Ic and past image Ip are not limited to being images captured by visible, infrared or ultraviolet light, but can also be X-ray images, ultrasound images, etc. Thus, the new image Ic and the past image Ip can be images of any part of the body captured by any method, as long as the images may have differences in the capture conditions due to the capture times.

In the above embodiments, the image processing device 10 includes each component illustrated in FIG. 2. However, the components of the image processing device 10 are not limited to being included in one device, but may also exist in different devices that are independent of each other. For example, any component of the image acquirer 111, the preprocessor 112, the cutter 113, the corrector 114, and the image outputter 115 of the processor 11 may be provided in a device different from that of the other components. In such a case, devices including each component can be referred to as an image processing device together. In the above embodiments, the imaging device 5 is a device different from the image processing device 10. However, the imaging device 5 may be included in the image processing device 10. In other words, the image processing device 10 may be integrated with the imaging device 5 to form a single unit, or may reside at a distance from the imaging device 5. In a case where the image processing device 10 is integrated with the imaging device 5 to form a single unit, the integrated unit may be referred to as the image processing device.

In the above embodiments, in the processor 11, the CPU functions as the components illustrated in FIG. 2 by executing a program stored in the ROM or the storage 12. However, the processor 11 may be dedicated hardware. The dedicated hardware is, for example, a single circuit, a composite circuit, a programmed processor, an application specific integrated circuit (ASIC), a field-programmable gate array (FPGA), or a combination of the foregoing. In the case where the processor 11 is dedicated hardware, each of the functions of the components may be achieved by an individual piece of hardware, or the functions of the components may be collectively achieved by a single piece of hardware. In addition, among the functions of the components, some functions may be achieved by dedicated hardware and the other functions may be achieved by software or firmware. As described above, the processor 11 can achieve the above-described functions by hardware, software, firmware, or a combination thereof.

By applying the program that defines the operation of the image processing device 10 described above to an existing computer, such as a personal computer or cloud server, it is also possible to cause the computer to function as the image processing device 10 described above. In addition, a method for distributing such a program is arbitrarily determined, and the program may be distributed stored in a computer-readable recording medium, such as a compact disk ROM (CD-ROM), a digital versatile disk (DVD), a magneto optical disk (MO), and a memory card, or may be distributed via a communication network, such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An image processing device comprising:
a memory to store a first image that is a captured image of a lesion candidate and a second image that is a captured image of the lesion candidate taken at a different time from the first image; and
at least one processor to read the first image and the second image from the memory and perform correction on the first image or the second image,
the at least one processor being configured to
obtain, based on a histogram of luminance in a region including the lesion candidate in the first image, a first representative luminance value that is a representative value of luminance in a surrounding area of the lesion candidate in the first image,
obtain, based on a histogram of luminance in a region including the lesion candidate in the second image, a second representative luminance value that is a representative value of luminance in a surrounding area of the lesion candidate in the second image, and
correct, based on the first representative luminance value and the second representative luminance value, the luminance in the region including the lesion candidate in the second image such that the second representative luminance value in the second image after the correction equals or approaches the first representative luminance value.

2. The image processing device according to claim 1, wherein
the at least one processor is configured to
in correcting the luminance in the region including the lesion candidate in the second image, multiply the luminance in the region including the lesion candidate by a value obtained by dividing the first representative luminance value by the second representative luminance value.

3. The image processing device according to claim 1, wherein
the at least one processor is configured to
in correcting the luminance in the region including the lesion candidate in the second image, add a value obtained by subtracting the second representative luminance value from the first representative luminance value to the luminance in the region including the lesion candidate.

4. The image processing device according to claim 1, wherein
the at least one processor is configured to
obtain a first representative chrominance value that is a representative value of chrominance in the surrounding area of the lesion candidate in the first image,
obtain a second representative chrominance value that is a representative value of chrominance in the surrounding area of the lesion candidate in the second image, and
correct, based on the first representative chrominance value and the second representative chrominance value, the chrominance in the region including the lesion candidate in the second image such that the second representative chrominance value in the second image after the correction equals or approaches the first representative chrominance value.

5. The image processing device according to claim 1, wherein
the at least one processor is configured to
display, alongside the first image on a display, the second image corrected such that the second representative luminance value equals or approaches the first representative luminance value.

6. The image processing device according to claim 5, wherein
the at least one processor is configured to
in a case of displaying the second image alongside the first image on the display, display an image obtained by cutting out, from the first image, the region including the lesion candidate in the first image, and display an image obtained by cutting out, from the second image, the region including the lesion candidate in the second image.

7. An image processing method, comprising:
by a computer including a memory to store a first image that is a captured image of a lesion candidate and a second image that is a captured image of the lesion candidate taken at a different time from the first image and configured to read the first image and the second image from the memory and perform correction on the first image or the second image,
obtaining, based on a histogram of luminance in a region including the lesion candidate in the first image, a first representative luminance value that is a representative value of luminance in a surrounding area of the lesion candidate in the first image,
obtaining, based on a histogram of luminance in a region including the lesion candidate in the second image, a second representative luminance value that is a representative value of luminance in a surrounding area of the lesion candidate in the second image, and
correcting, based on the first representative luminance value and the second representative luminance value, the luminance in the region including the lesion candidate in the second image such that the second representative luminance value in the second image after the correction equals or approaches the first representative luminance value.

8. The image processing method according to claim 7, the method comprising, by the computer,
in correcting the luminance in the region including the lesion candidate in the second image, multiplying the luminance in the region including the lesion candidate by a value obtained by dividing the first representative luminance value by the second representative luminance value.

9. The image processing method according to claim 7, the method comprising, by the computer,
in correcting the luminance in the region including the lesion candidate in the second image, adding a value obtained by subtracting the second representative luminance value from the first representative luminance value to the luminance in the region including the lesion candidate.

10. The image processing method according to claim 7, the method comprising, by the computer,
obtaining a first representative chrominance value that is a representative value of chrominance in the surrounding area of the lesion candidate in the first image,
obtaining a second representative chrominance value that is a representative value of chrominance in the surrounding area of the lesion candidate in the second image, and
correcting, based on the first representative chrominance value and the second representative chrominance value, the chrominance in the region including the lesion candidate in the second image such that the second representative chrominance value in the second image after the correction equals or approaches the first representative chrominance value.

11. The image processing method according to claim 7, the method comprising, by the computer,
displaying, alongside the first image on a display, the second image corrected such that the second representative luminance value equals or approaches the first representative luminance value.

12. The image processing method according to claim 11, the method comprising, by the computer,
in a case of displaying the second image alongside the first image on the display, displaying an image obtained by cutting out, from the first image, the region including the lesion candidate in the first image, and displaying an image obtained by cutting out, from the second image, the region including the lesion candidate in the second image.

13. A non-transitory computer-readable recording medium storing a program executable by a computer, the computer including a memory to store a first image that is a captured image of a lesion candidate and a second image that is a captured image of the lesion candidate taken at a different time from the first image and being configured to read the first image and the second image from the memory and perform correction on the first image or the second image, the program causing the computer to function as a processor configured to
obtain, based on a histogram of luminance in a region including the lesion candidate in the first image, a first representative luminance value that is a representative value of luminance in a surrounding area of the lesion candidate in the first image,
obtain, based on a histogram of luminance in a region including the lesion candidate in the second image, a second representative luminance value that is a representative value of luminance in a surrounding area of the lesion candidate in the second image, and
correct, based on the first representative luminance value and the second representative luminance value, the luminance in the region including the lesion candidate in the second image such that the second representative luminance value in the second image after the correction equals or approaches the first representative luminance value.

14. The recording medium according to claim 13, wherein
the processor
in correcting the luminance in the region including the lesion candidate in the second image, multiplies the luminance in the region including the lesion candidate by a value obtained by dividing the first representative luminance value by the second representative luminance value.

15. The recording medium according to claim 13, wherein
the processor
in correcting the luminance in the region including the lesion candidate in the second image, adds a value obtained by subtracting the second representative luminance value from the first representative luminance value to the luminance in the region including the lesion candidate.

16. The recording medium according to claim 13, wherein
the processor
obtains a first representative chrominance value that is a representative value of chrominance in the surrounding area of the lesion candidate in the first image,
obtains a second representative chrominance value that is a representative value of chrominance in the surrounding area of the lesion candidate in the second image, and
corrects, based on the first representative chrominance value and the second representative chrominance value, the chrominance in the region including the lesion candidate in the second image such that the second representative chrominance value in the second image after the correction equals or approaches the first representative chrominance value.

17. The recording medium according to claim 13, wherein
the processor
displays, alongside the first image on a display, the second image corrected such that the second representative luminance value equals or approaches the first representative luminance value.

18. The recording medium according to claim 17, wherein
the processor
in a case of displaying the second image alongside the first image on the display, displays an image obtained by cutting out, from the first image, the region including the lesion candidate in the first image, and displays an image obtained by cutting out, from the second image, the region including the lesion candidate in the second image.
